(19) United States
(12) Patent Application Publication
(10) Pub. No.: US 2014/0320172 A1
(43) Pub. Date: Oct. 30, 2014

(54) CURRENT-TO-VOLTAGE CONVERTER AND ELECTRONIC APPARATUS THEREOF

(71) Applicant: ILI TECHNOLOGY CORP., Hsinchu County (TW)

(72) Inventors: CHENG-CHUNG HSU, HSINCHU COUNTY (TW); CHIH-JEN CHENG, HSINCHU CITY (TW)

(73) Assignee: ILI TECHNOLOGY CORP., Hsinchu County (TW)

(21) Appl. No.: 13/972,995

(22) Filed: Aug. 22, 2013

(30) Foreign Application Priority Data
Apr. 29, 2013 (TW) 102115232

(51) Int. Cl. H02M 11/00

(52) U.S. Cl. CPC H02M 11/00
USPC 327/103

(57) ABSTRACT

A current-to-voltage converter comprises a gain circuit, a flip circuit, and a chopper circuit. The gain circuit receives an input current, and amplifies the input current to generate an amplified current. The flip circuit receives the amplified current, and uses the amplified current to charge or discharge a capacitor thereof according to a charge signal and a discharge signal, so as to generate an output voltage, wherein before using the amplified current to charge or discharge the capacitor, the flip circuit resets the output voltage respectively to a charge reset voltage and a discharge reset voltage according to a charge reset signal and a discharge reset signal. When the capacitor is charged, the chopper circuit samples and holds the output voltage to generate a recovered voltage. When the capacitor is discharged, the chopper circuit samples, holds, and flips the output voltage to generate the recovered voltage.

### BACKGROUND

1. Technical Field

The present disclosure is related to a current current-to-voltage converter, and in particular to, a single stage current-to-voltage converter which is applied in a touch control sensor, and the electronic apparatus using the current-to-voltage converter.

2. Description of Related Art

The marketed general electronic apparatus has a current-to-voltage converter, wherein the current-to-voltage converter can covert the current to the voltage, and transmit the converted voltage to a function circuit of the electronic apparatus, such that the function circuit can receive the voltage and perform a corresponding function based on the voltage. In the application of the touch control sensor, the current current-to-voltage converter can have a gain circuit and a flip circuit, wherein the gain circuit acts as a current amplifier, and based on the control of the charge signal and the discharge signal, the flip circuit generates an output voltage in response to the current output from and amplified by the gain circuit. The flip circuit thus can flip the negative signal to the positive signal through the above action, so as to increase the dynamic range of current-to-voltage converter.

Referring to FIG. 1, FIG. 1 is a circuit diagram of the conventional current current-to-voltage converter. The conventional current current-to-voltage converter 1 comprises a gain circuit 11 and a flip circuit 12, wherein the gain circuit 11 is connected to the flip circuit 12. The gain circuit 11 comprises a plurality of N-type transistors N1 through N3 and a plurality of P-type transistors P1 through P3, and the flip circuit comprises a plurality of N-type transistors N4 through N7, a plurality of P-type transistors P4 through P6, a plurality of current sources CS1 through CS4, a capacitor Cint, and a plurality of switches SW1 through SW3.

The gain circuit 11 is a current amplifier, receives an input current Iin corresponding to a driving signal Vdrv through the capacitor Ct, and amplifies the input current Iin to generate a first current. To put it concretely, the gain circuit 11 is formed by two current mirrors, wherein two ends of the current mirror are connected to each other, and other two ends of the current mirrors are respectively connected a supply voltage VDD and a ground GND. One of the current mirrors is formed by P-type transistors P1, P2, and a N-type transistor N1, and a bias voltage biasa is applied thereto; the other one current mirror is formed by a P-type transistor P3, and N-type transistors N2, N3, and a bias voltage biasb is applied thereto.

The flip circuit 12 receives a first current, generates an output voltage Vout according to the first current. To put it concretely, the current sources CS1 through CS4, N-type transistors N4 through N7, P-type transistors P4 through P6 form a plurality of current mirrors, the current mirrors generate a second current according to the first current, and the switches SW1 and SW2 are respectively controlled by the charge signal Φ_{C} and the discharge signal Φ_{DC}, such that the second current can be used to charge or discharge the capacitor Cint to generate the output voltage Vout. In addition, one switch SW3 of the flip circuit 12 is further controlled by the reset signal Φ_{RST}, so as to determine whether the output voltage Vout is reset to the reset voltage V_{RST}.

Referring to FIG. 1 and FIG. 2, FIG. 2 is a waveform diagram of portion of signals in the conventional current current-to-voltage converter. As shown in FIG. 2, before the driving signal Vdrv changes to the logic high level from the logic low level, the discharge signal Φ_{DC} would changes to the logic high level (the switch SW1 would be shorted) from the logic low level, the charge signal Φ_{C} would maintain the logic low level (the switch SW2 would be opened), and the reset signal Φ_{RST} would change to the logic high level (the switch SW3 would be shorted) from the logic low level, so as to reset the output voltage Vout to the reset voltage V_{RST}, firstly. Next, the driving signal Vdrv would change to the logic high level from the logic low level, and the reset signal Φ_{RST} would change to the logic low level (the switch SW3 would be opened) from the logic high level. Meanwhile, the discharge signal Φ_{DC} would maintain the logic high level (the switch SW1 would be shorted), such that the second current discharges the capacitor Cint, and a positive output voltage Vout is thus output.

Next, the discharge signal Φ_{DC} changes from the logic high level to the logic low level (the switch SW1 would be opened), and the charge signal Φ_{C} and the reset signal Φ_{RST} would change from the logic low level to the logic high level (the switches SW2 and SW3 would be shorted), so as to reset the output voltage Vout to the reset voltage V_{RST} before the driving signal Vdrv changes to the logic low level from the logic high level. Then, the driving signal Vdrv would change to the logic low level from the logic high level, and the reset signal Φ_{RST} would change from the logic high level to the logic low level (the switch SW3 would be shorted). Meanwhile, the charge signal Φ_{C} would maintain the logic high level (the switch SW2 would be shorted), such that the second current charges the capacitor Cint, and the positive output voltage Vout is thus output. It is known that the flip circuit 12 can convert the negative input current Iin corresponding to the negative driving signal Vdrv to the positive output voltage Vout.

From the above descriptions, it is known that the generated current consumption is very large since the flip circuit 12 of the conventional current-to-voltage converter 1 has several current mirrors. Furthermore, since the conventional current-to-voltage converter 1 has two current paths (the charge and discharge paths), the intrinsic circuit mismatch calibration becomes complex.

### SUMMARY

An exemplary embodiment of the present disclosure provides a current-to-voltage converter comprising a gain circuit, a flip circuit, and a chopper circuit, wherein the flip circuit is connected to the gain circuit, and the chopper circuit is connected to the flip circuit. The gain circuit receives an input current, and amplifies the input current, to generate an amplified current. The flip circuit receives the amplified current, and uses the amplified current to charge or discharge a capacitor thereof according to a control of a charge signal and a discharge signal, so as to generate an output voltage, wherein before using the amplified current to charge and discharge the capacitor, the flip circuit resets the output voltage respectively to a charge reset voltage and a charge reset voltage and a discharge reset voltage according to a charge reset signal and a discharge reset signal. Before the capacitor is charged, the chopper circuit samples and holds the output voltage to generate a recovered voltage, and before the capacitor is discharged, the chopper circuit samples, holds, and flips the output voltage to generate the recovered voltage.

In one preferred exemplary embodiment of the present disclosure, the flip circuit comprises a capacitor and a first through fourth switches. One end of the capacitor is connected to the output voltage. The first switch is controlled by the discharge reset signal, and two ends of the first switch are respectively connected to the discharge reset voltage and the output voltage. The second switch is controlled by the charge reset signal, and two ends of the second switch are respectively to the charge reset voltage and the output voltage. The third switch is controlled by discharge signal, and two ends of the third switch are respectively connected to a supply voltage and another end of the capacitor. The fourth switch is controlled by the charge signal, and two ends of the fourth switch are respectively connected to a ground and the other end of the capacitor.

In one preferred exemplary embodiment of the present disclosure, the current-to-voltage converter further comprises an analog-to-digital converter connected to the chopper circuit. The analog-to-digital converter performs a current-to-voltage conversion on the recovered voltage to generate a digital voltage.

In one preferred exemplary embodiment of the present disclosure, the analog-to-digital converter has a positive input end and a negative input end, and the chopper circuit comprises an operation amplifier, a first through fourth capacitors, and a fifth through eighth switches. The operation amplifier has a positive input end, a negative input end, a positive output end, and a negative output end. Two ends of the first capacitor are respectively connected to the output voltage and the positive input end of the operation amplifier. Two ends of the second capacitor are respectively connected to a ground and the negative input end of the operation amplifier. Two ends of the third capacitor are respectively connected to the positive input end and the negative output end of the operation amplifier. Two ends of the fourth capacitor are respectively connected to the negative input end and the positive output end of the operation amplifier. The fifth switch is controlled by a discharge sample-and-hold signal, and two ends of the fifth switch are respectively connected to the negative output end of the operation amplifier and the positive input end of the analog-to-digital converter. The sixth switch is controlled by a charge sample-and-hold signal, and two ends of the sixth switch are respectively connected to the negative output end of the operation amplifier and the negative input end of the analog-to-digital converter. The seventh switch is controlled by the charge sample-and-hold signal, and two ends of the seventh switch are respectively connected to the positive output end of the operation amplifier and the positive input end of the analog-to-digital converter. The eighth switch is controlled by the discharge sample-and-hold signal, and two ends of the eighth switch are respectively connected to the positive output end of the operation amplifier and the negative input end of the analog-to-digital converter.

An exemplary embodiment of the present disclosure further provides an electronic apparatus, and the electronic apparatus comprises the mentioned current current-to-voltage converter and a function circuit, wherein the function circuit is connected to the current current-to-voltage converter. The function circuit receives the output voltage, and executes a corresponding function accordingly.

To sum up, the current current-to-voltage converter provided by the exemplary embodiment of the present disclosure can reduce the current consumption, and maintain the same dynamic range of the input current. In addition, the structure the current current-to-voltage converter provided by the exemplary embodiment of the present disclosure is simple to implement, and the current current-to-voltage converter can avoid the mismatch between the charge and discharge paths.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a circuit diagram of the conventional current current-to-voltage converter.

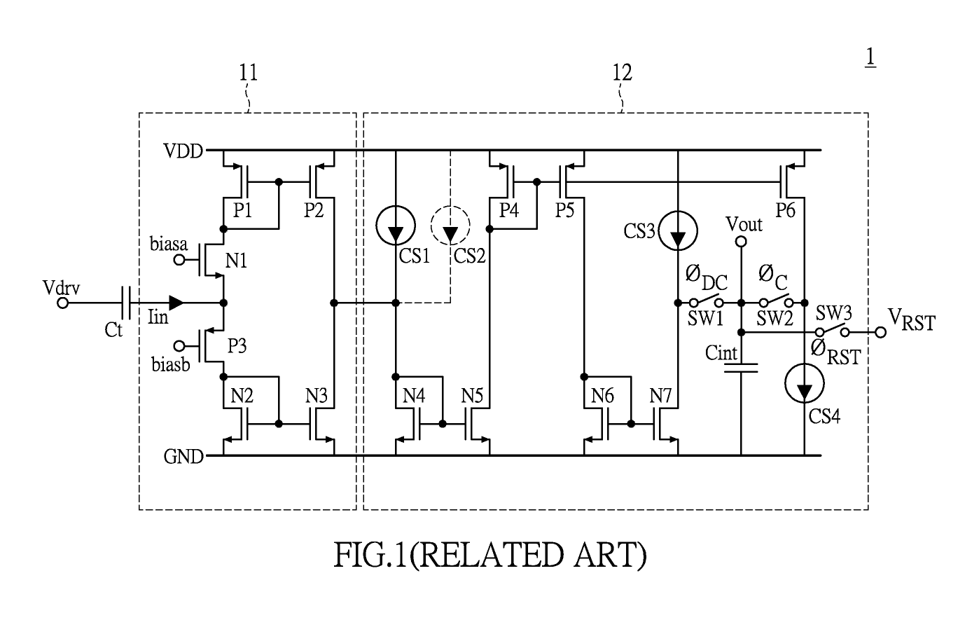

FIG. 2 is a waveform diagram of portion of signals in the conventional current current-to-voltage converter.

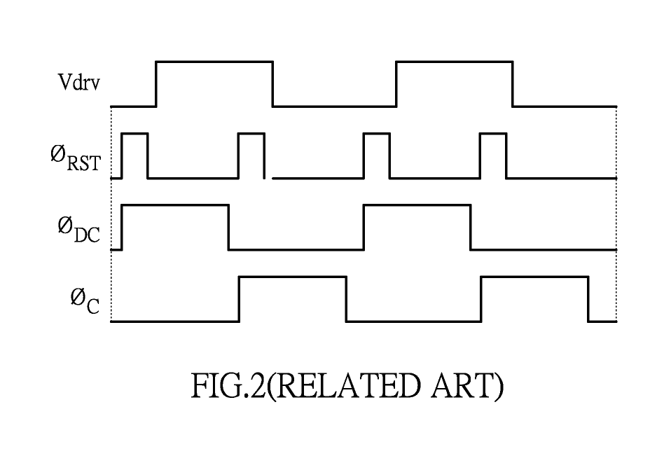

FIG. 3 is a block diagram of a current current-to-voltage converter according to an exemplary embodiment of the present disclosure.

FIG. 4 is a circuit diagram of a gain circuit and a flip circuit of the current current-to-voltage converter according to an exemplary embodiment of the present disclosure.

FIG. 5A is an equivalent circuit diagram of a gain circuit and a flip circuit of the current current-to-voltage converter according to an exemplary embodiment of the present disclosure, while the charge signal is the logic high level.

FIG. 5B is an equivalent circuit diagram of a gain circuit and a flip circuit of the current current-to-voltage converter according to an exemplary embodiment of the present disclosure, while the discharge signal is the logic high level.

FIG. 6 is a circuit diagram of a chopper circuit and an analog-to-digital converter of the current current-to-voltage converter according to an exemplary embodiment of the present disclosure.

FIG. 7 is a waveform diagram of portion of signals in the current current-to-voltage converter according to an exemplary embodiment of the present disclosure.

FIG. 8 is a block diagram of an electronic apparatus according to an exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or similar parts.

[Exemplary Embodiment of Current-to-Voltage Converter]

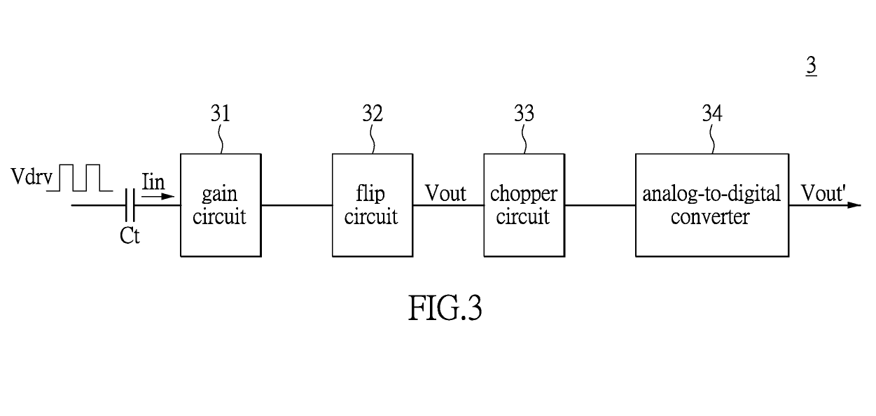

The current current-to-voltage converter in the exemplary embodiment of the present disclosure uses the switch capacitor and chopping technology to increase the dynamic range of the input current. Referring to FIG. 3, FIG. 3 is a block diagram of a current current-to-voltage converter according to an exemplary embodiment of the present disclosure. The current-to-voltage converter 3 comprises a gain circuit 31, a flip circuit 32, a chopper circuit 33, and an analog-to-digital converter 34, wherein the gain circuit 31 is connected to the flip circuit 32, the flip circuit 32 is connected to the chopper circuit 33, and the chopper circuit 33 is connected to the analog-to-digital converter 34.

The gain circuit 31 is a current amplifier, receives an input current Iin corresponding to a driving signal through a capacitor Ct, and generates an amplified current. The flip circuit 32 receives the amplified current, and generates an output voltage Vout according to the amplified current. To put it concretely, the flip circuit 32 is controlled by a charge signal Φ_{C} and a discharge signal Φ_{DC}, such that the amplified current can charge or discharge a capacitor of the flip circuit 32 to generate the output voltage Vout. When the input current Iin is a negative current, the flip circuit 32 charges the capacitor thereof, such that the output voltage Vout is raised to a second level from a first level, wherein the first level is less than the second level. In addition, when the input current Iin is a positive current, the flip circuit 32 discharges the capacitor thereof, such the output voltage Vout is pulled down a fourth level from a third level, wherein the fourth level is less than the third level. In addition, before the flip circuit 32 charges the capacitor thereof, the flip circuit 32 may reset the output voltage to the first level; and before the flip circuit 32 discharges the capacitor thereof, the flip circuit 32 may reset the output voltage to the third level.

Next, the chopper circuit 33 is used to sample and hold the output voltage Vout, and uses the chopper technology to recover the output voltage Vout to generate a recovered voltage. The analog-to-digital converter 34 is used to receive the recovered voltage, and performs an analog-to-digital conversion on the recovered voltage to output a digital voltage Vout′. It is noted that, during a period that the output voltage Vout is raised to the second level from the first level, the chopper circuit 33 samples and holds the output voltage Vout to obtain the recovered voltage with the logic high level; during the period that the output voltage Vout is pulled down to the fourth level from the third level, the chopper circuit 33 samples and holds the output voltage Vout, and then flips the sample-and-hold voltage to obtain the recovered voltage with the logic high level.

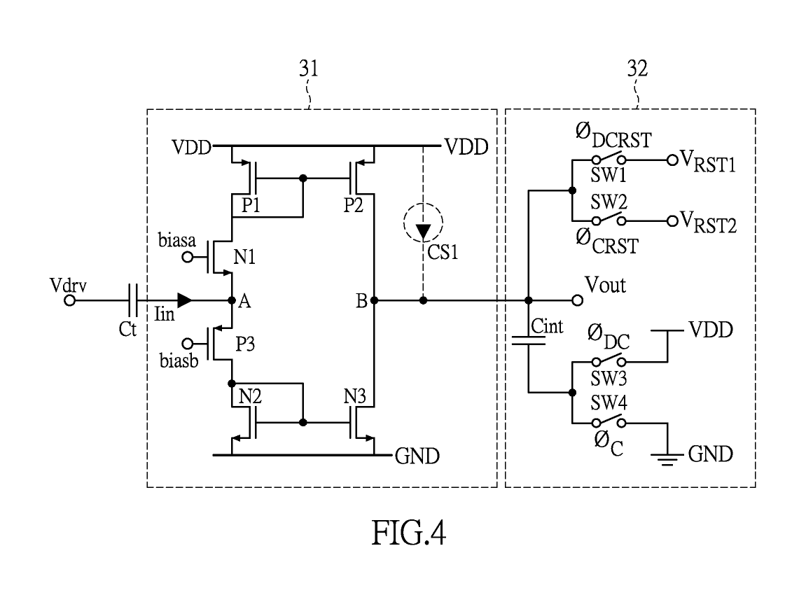

Referring to FIG. 4, FIG. 4 is a circuit diagram of a gain circuit and a flip circuit of the current current-to-voltage converter according to an exemplary embodiment of the present disclosure. The gain circuit 31 comprises P-type transistors P1 through P3, N-type transistors N1 through N3, and a current source CS1, wherein the current source CS1 is not a required element and can be removed. The gain circuit 31 is consisted of two current mirrors, two ends of the two current mirrors are connected to each other, and another two ends of the two current mirrors are respectively connected to a supply voltage VDD and a ground GND. One of the above current mirrors is consisted of the P-type transistors P1, P2, and the N-type transistor N1, and is applied with a bias voltage biasa; the other one of the above current mirrors is consisted of the P-type transistor P3 and the N-type transistors N2, N3, and is applied with a bias voltage biasb.

Next, the detailed structure of the gain circuit 31 is further described. The sources of the P-type transistors P1, P2 are connected to the supply voltage VDD, and the gates of the P-type transistors P1, P2 are connected to each other. The drain of the N-type transistor N1 is connected to the gate and the drain of the P-type transistor P1, and the source of the N-type transistor N1 and the drain of the P-type transistor P2 are respectively connected to the ends A and B, wherein the end A is used to receive the input current Iin, and the end B is used to output the output voltage Vout to the chopper circuit 33.

The sources of the N-type transistors N2, N3 is connected to the ground GND, and the gates of the N-type transistors N2, N3 are connected to each other. The drain of the P-type transistor P3 is connected to the gate and the drain of the N-type transistor N2, and the source of the P-type transistor P3 and the drain of the N-type transistor N3 are respectively connected to the ends A and B. In addition, the two ends of the current source CS1 are respectively connected the supply voltage VDD and the end B.

Next, the detailed structure of the flip circuit 32 is further described. The flip circuit 32 comprises a capacitor Cint and switches SW1 through SW4. The switches SW1 through SW4 are respectively controlled by the discharge reset signal Φ_{DCRST}, the charge reset signal Φ_{CRST}, the discharge signal Φ_{DC}, and the charge signal Φ_{C}. The two ends of the switch SW1 are respectively connected to the discharge reset voltage V_{RST1} with the third level and the end B, and the two ends of the switch SW2 are respectively connected to the discharge reset voltage V_{RST2} with the first level and the end B. The two ends of the switch SW3 are respectively connected to the supply voltage VDD and one end of the capacitor Cint, and the two ends of the switch SW4 are respectively connected to the ground GND and one end of the capacitor Cint. The other one end of the capacitor Cint is connected to the end B.

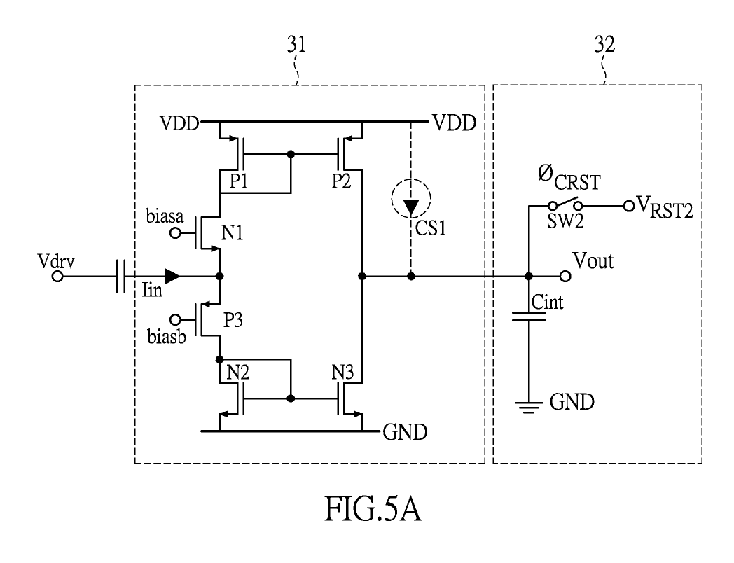

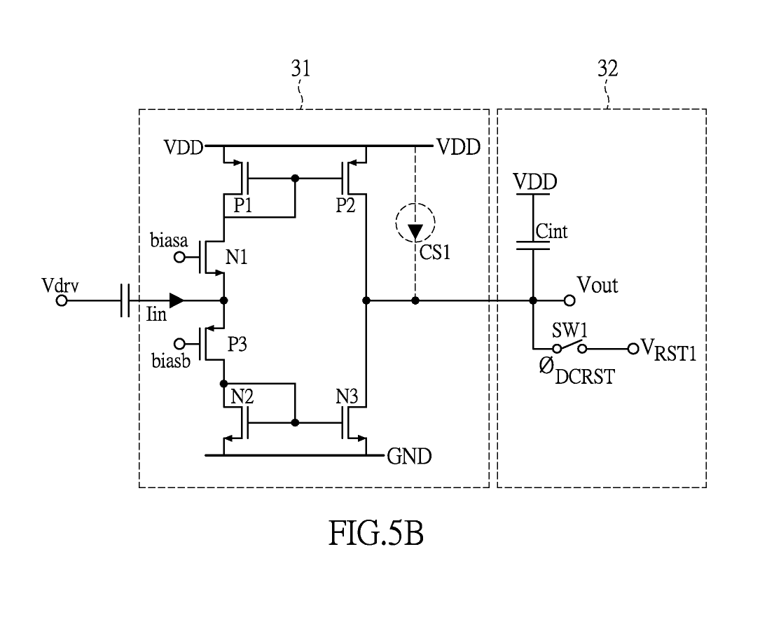

In the exemplary embodiment of the present disclosure, the discharge signal Φ_{DC} and the discharge reset signal Φ_{DCRST} are one pair of control signals for charging the capacitor Cint; in addition, the charge signal Φ_{C} and the charge reset signal Φ_{CRST} are one pair of control signals for discharging the capacitor Cint. When the input current Iin corresponding to the driving signal is the negative current, the switches SW1 and SW3 are opened (i.e. the discharge reset signal Φ_{DCRST} and the discharge signal Φ_{DC} are the logic low levels), the switch SW4 is shorted (i.e. the charge signal Φ_{C} is the logic high level), and the switch SW2 is shorted for a temporal period merely before the input current Iin corresponding to the driving signal Vdrv changes to the negative current from the positive current. From the above descriptions, while the charge signal Φ_{C} is the logic high level, the equivalent circuit of the gain circuit 31 and the flip circuit 32 of the current-to-voltage converter 3 is shown in FIG. 5A. Meanwhile, the output voltage Vout would be raised to the second level from the first level.

When the input current Iin corresponding to the driving signal Vdrv is the positive current, the switches SW2 and SW4 would be opened (i.e. the charge reset signal Φ_{CRST} and the charge signal Φ_{C} are the logic low levels), the switch SW3 would be shorted (i.e. the discharge signal Φ_{DC} is the logic high level), and the switch SW1 is shorted for a temporal period merely before the input current Iin corresponding to the driving signal Vdrv changes to the positive current from the negative current. From the above descriptions, while the discharge signal Φ_{DC} is the logic high level, the equivalent circuit of the gain circuit 31 and the flip circuit 32 of the current-to-voltage converter 3 is shown in FIG. 5B. Meanwhile, the output voltage Vout would be pulled down to the fourth level from the third level.

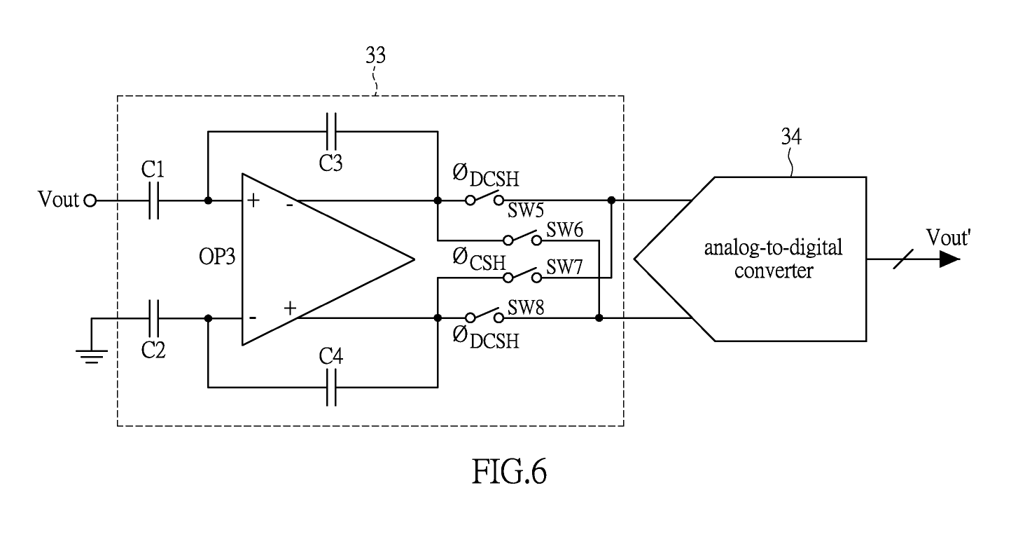

Referring to FIG. 6, FIG. 6 is a circuit diagram of a chopper circuit and an analog-to-digital converter of the current current-to-voltage converter according to an exemplary embodiment of the present disclosure. The chopper circuit 33 comprises an operation amplifier OP3, capacitors C1 through C4, and switches SW5 through SW8. The operation amplifier OP3 a differential operation amplifier having a positive input end, a negative input end, a positive output end, and a negative output end. In addition, the analog-to-digital converter 34 is also a differential analog-to-digital converter having a positive input end and a negative input end.

The operation amplifier OP3 and the capacitors C1 through C4 form a sample-and-hold circuit. Furthermore, the switches SW5 and SW8 are controlled by the discharge sample-and-hold signal Φ_{PCSH}, and the switches SW6 and SW7 are controlled by the charge sample-and-hold signal Φ_{CSH}. Thus, when the discharge signal Φ_{DC} is the logic high level, the chopper circuit 33 not only has the sample and hold functions, but also has the flip function; and when the charge signal Φ_{c} is the logic high level, the chopper circuit 33 merely has the sample and hold functions.

Next, the detailed structure of the chopper circuit 33 is further described. The two ends of the capacitor C1 are respectively connected to the output voltage Vout and the positive input end of the operation amplifier OP3, and the two ends of the capacitor C2 are respectively connected to the ground GND and the negative input end of the operation amplifier OP3. The two ends of the capacitor C3 are respectively connected to the positive input end and the negative output end of the operation amplifier OP3, and the two ends of the capacitor C4 are respectively connected to the negative input end and the positive output end of the operation amplifier OP3. The two ends of the switch SW5 are respectively connected to the negative output end of the operation amplifier OP3 and the positive input end of the analog-to-digital converter 34, and the two ends of the switch SW8 are respectively connected to the positive output end of the operation amplifier OP3 and the negative input end of the analog-to-digital converter 34. The two ends of the switch SW6 are respectively connected to the negative output end of the operation amplifier OP3 and the negative input end of the analog-to-digital converter 34, and the two ends of the switch SW7 are respectively connected to the positive output end of the operation amplifier OP3 and the positive input end of the analog-to-digital converter 34.

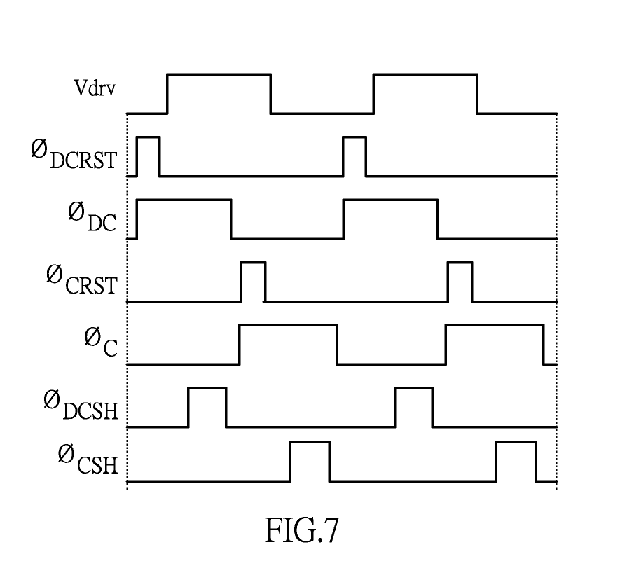

Referring to FIG. 4, FIG. 6, and FIG. 7, FIG. 7 is a waveform diagram of portion of signals in the current current-to-voltage converter according to an exemplary embodiment of the present disclosure. Before the driving signal Vdrv changes to the logic high level from the logic low level, the discharge signal Φ_{DC} would change from the logic low level to the logic high level (the switch SW3 would be shorted), the charge signal Φ_{C} would maintain the logic low level (the switch SW4 would be opened), and the discharge reset signal Φ_{DCRST} would also change from the logic low level to the logic high level (the switch SW1 would be shorted), so as to reset the output voltage Vout to the reset voltage V_{RST1}, firstly. Next, the driving signal Vdrv would change to the logic high level from the logic low level, and the discharge reset signal Φ_{DCRST} DCRST would change to the logic low level from the logic high level (the switch SW1 would be opened). Meanwhile the discharge signal Φ_{DC} would maintain the logic high level (the switch SW3 would be shorted), such that the amplified current would discharge the capacitor Cint, and the output voltage Vout between the third level and the fourth level is thus output. Then, before the discharge signal Φ_{DC} changes from the logic high level to the logic low level, the discharge sample-and-hold signal Φ_{DCSH} would change from the logic low level to the logic high level (the switches SW5 and SW8 would be shorted), and the charge sample-and-hold signal Φ_{CSH} would maintain the logic low level (the switches SW6 and SW7 would be opened), such that the chopper circuit 33 samples, holds, and flips the output voltage Vout.

Then, the discharge signal Φ_{DC} would change from the logic high level to the logic low level (the switch SW3 would be opened), and the charge signal Φ_{C} and the charge reset signal Φ_{CRST} would change from the logic low level to the logic high level (the switches SW2 and SW4 would be shorted), so as to reset the output voltage Vout to the reset voltage V_{RST2} before the driving signal changes to the logic low level from the logic high level. Then, the driving signal Vdrv would change from the logic low level to the logic high level, and the charge reset signal Φ_{CRST} would change from the logic high level to the logic low level (the switch SW2 would be opened). Meanwhile, the charge signal Φ_{C} would maintain the logic high level (the switch SW4 would be shorted), such that the amplified current charges the capacitor Cint, and the output voltage Vout between the first level and the second level is thus output. Then, before the charge signal Φ_{C} changes from to the logic low level from the logic high level, the charge sample-and-hold signal Φ_{CSH} would change from the logic low level to the logic high level (the switches SW6 and SW7 would be shorted), and the discharge sample-and-hold signal Φ_{DCSH} would maintain the logic low level (the switches SW5 and SW8 would be opened), such that the chopper circuit 33 samples and holds the output voltage Vout.

[Exemplary Embodiment of Electronic Apparatus]

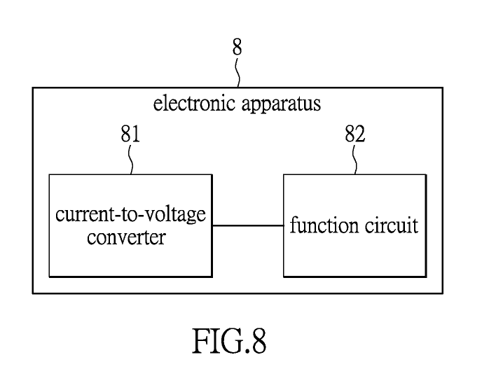

Referring to FIG. 8, FIG. 8 is a block diagram of an electronic apparatus according to an exemplary embodiment of the present disclosure. The electronic apparatus 8 comprises a current-to-voltage converter 81 and a function circuit 82, wherein the current-to-voltage converter 81 is connected to the function circuit 82, and the current current-to-voltage converter 81 can be anyone of current-to-voltage converters in the exemplary embodiments of the present disclosure or the modification. The current-to-voltage converter 81 receives the current Iin, and outputs the output voltage Vout to the function circuit 82. The function circuit 82 executes the corresponding function according to the received output voltage Vout. The electronic apparatus 8 can be the touch control apparatus for example, and the function circuit 82 can be the touch control circuit. However, it is noted that the number and type of the function circuit 82 corresponding to the type of the electronic apparatus 8 are not used to limit the present disclosure, and the type of the electronic apparatus 8 is not used to limit the present disclosure, either.

[Possible Result of Exemplary Embodiment]

Accordingly, the current current-to-voltage converter provided by the exemplary embodiment of the present disclosure can reduce the current consumption, and maintain the same dynamic range of the input current. In addition, the structure the current current-to-voltage converter provided by the exemplary embodiment of the present disclosure is simple to implement, and the current current-to-voltage converter can avoid the mismatch between the charge and discharge paths.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A current-to-voltage converter, comprising:
a gain circuit, receiving an input current, and amplifying the input current, to generate an amplified current;
a flip circuit, connected to the gain circuit, receiving the amplified current, and using the amplified current to charge or discharge a capacitor thereof according to a control of a charge signal and a discharge signal, so as to generate an output voltage, wherein before using the amplified current to charge and discharge the capacitor, the flip circuit resets the output voltage respectively to a charge reset voltage and a charge reset voltage and a discharge reset voltage according to a charge reset signal and a discharge reset signal; and
a chopper circuit, connected to the flip circuit, wherein before the capacitor is charged, the chopper circuit samples and holds the output voltage to generate a recovered voltage, and before the capacitor is discharged, the chopper circuit samples, holds, and flips the output voltage to generate the recovered voltage.

2. The current-to-voltage converter according to claim 1, wherein when the input current is a negative current, the capacitor is charged; and when the input current is a positive current, the capacitor is discharged.

3. The current-to-voltage converter according to claim 1, further comprising:
an analog-to-digital converter, connected to the chopper circuit, performing a current-to-voltage conversion on the recovered voltage to generate a digital voltage.

4. The current-to-voltage converter according to claim 1, wherein the gain circuit comprises two current mirrors, two ends of the current mirrors are connected to each other, and other two ends of the current mirrors are respectively connected to a supply voltage and a ground.

5. The current-to-voltage converter according to claim 4, wherein the gain circuit further comprises a current source, two ends of the current source are respectively connected to the supply voltage and to the output voltage.

6. The current-to-voltage converter according to claim 1, wherein the flip circuit comprises:
a capacitor, one end thereof is connected to the output voltage;
a first switch, controlled by the discharge reset signal, two ends thereof are respectively connected to the discharge reset voltage and the output voltage;
a second switch, controlled by the charge reset signal, two ends thereof are respectively to the charge reset voltage and the output voltage;
a third switch, controlled by discharge signal, two ends thereof are respectively connected to a supply voltage and another end of the capacitor; and
a fourth switch, controlled by the charge signal, two ends thereof are respectively connected to a ground and the other end of the capacitor.

7. The current-to-voltage converter according to claim 3, wherein the analog-to-digital converter has a positive input end and a negative input end, and the chopper circuit comprises:
an operation amplifier, having a positive input end, a negative input end, a positive output end, and a negative output end;
a first capacitor, two ends thereof are respectively connected to the output voltage and the positive input end of the operation amplifier;
a second capacitor, two ends thereof are respectively connected to a ground and the negative input end of the operation amplifier;
a third capacitor, two ends thereof are respectively connected to the positive input end and the negative output end of the operation amplifier;
a fourth capacitor, two ends thereof are respectively connected to the negative input end and the positive output end of the operation amplifier;
a fifth switch, controlled by a discharge sample-and-hold signal, two ends thereof are respectively connected to the negative output end of the operation amplifier and the positive input end of the analog-to-digital converter;
a sixth switch, controlled by a charge sample-and-hold signal, two ends thereof are respectively connected to the negative output end of the operation amplifier and the negative input end of the analog-to-digital converter;
a seventh switch, controlled by the charge sample-and-hold signal, two ends thereof are respectively connected to the positive output end of the operation amplifier and the positive input end of the analog-to-digital converter; and
an eighth switch, controlled by the discharge sample-and-hold signal, two ends thereof are respectively connected to the positive output end of the operation amplifier and the negative input end of the analog-to-digital converter.

8. The current-to-voltage converter according to claim 1, wherein when the capacitor is charged, the output voltage is raised to a second level from a first level, and during a period that the output voltage is raised to the second level from the first level, the chopper circuit samples and holds the output voltage; when the capacitor is discharged, the output voltage is pulled down to a fourth level from a third level, and during a period that the output voltage is pulled down to the fourth level from the third level, the chopper circuit samples, holds, and flips the output voltage, wherein the second level is larger than the first level, and the third level is larger than the fourth level.

9. An electronic apparatus, comprising:
a current-to-voltage converter, comprising:
a gain circuit, receiving an input current, and amplifying the input current, to generate an amplified current;
a flip circuit, connected to the gain circuit, receiving the amplified current, and using the amplified current to charge or discharge a capacitor thereof according to a control of a charge signal and a discharge signal, so as to generate an output voltage, wherein before using the amplified current to charge and discharge the capacitor, the flip circuit resets the output voltage respectively to a charge reset voltage and a charge reset voltage and a discharge reset voltage according to a charge reset signal and a discharge reset signal; and
a chopper circuit, connected to the flip circuit, wherein before the capacitor is charged, the chopper circuit samples and holds the output voltage to generate a recovered voltage, and before the capacitor is discharged, the chopper circuit samples, holds, and flips the output voltage to generate the recovered voltage; and
a function circuit, connected to the current current-to-voltage converter, for receiving the output voltage, and executing a corresponding function accordingly.

10. The electronic apparatus according to claim 9, wherein when the input current is a negative current, the capacitor is charged; and when the input current is a positive current, the capacitor is discharged.

11. The electronic apparatus according to claim 9, wherein the current-to-voltage converter further comprises:
an analog-to-digital converter, connected to the chopper circuit, performing a current-to-voltage conversion on the recovered voltage to generate a digital voltage.

12. The electronic apparatus according to claim 9, wherein the gain circuit comprises two current mirrors, two ends of the current mirrors are connected to each other, and other two ends of the current mirrors are respectively connected to a supply voltage and a ground.

13. The electronic apparatus according to claim 12, wherein the gain circuit further comprises a current source, two ends of the current source are respectively connected to the supply voltage and to the output voltage.

14. The electronic apparatus according to claim 9, wherein the flip circuit comprises:
a capacitor, one end thereof is connected to the output voltage;
a first switch, controlled by the discharge reset signal, two ends thereof are respectively connected to the discharge reset voltage and the output voltage;
a second switch, controlled by the charge reset signal, two ends thereof are respectively to the charge reset voltage and the output voltage;
a third switch, controlled by discharge signal, two ends thereof are respectively connected to a supply voltage and another end of the capacitor; and
a fourth switch, controlled by the charge signal, two ends thereof are respectively connected to a ground and the other end of the capacitor.

15. The electronic apparatus according to claim 11, wherein the analog-to-digital converter has a positive input end and a negative input end, and the chopper circuit comprises:
an operation amplifier, having a positive input end, a negative input end, a positive output end, and a negative output end;
a first capacitor, two ends thereof are respectively connected to the output voltage and the positive input end of the operation amplifier;
a second capacitor, two ends thereof are respectively connected to a ground and the negative input end of the operation amplifier;
a third capacitor, two ends thereof are respectively connected to the positive input end and the negative output end of the operation amplifier;
a fourth capacitor, two ends thereof are respectively connected to the negative input end and the positive output end of the operation amplifier;
a fifth switch, controlled by a discharge sample-and-hold signal, two ends thereof are respectively connected to the negative output end of the operation amplifier and the positive input end of the analog-to-digital converter;
a sixth switch, controlled by a charge sample-and-hold signal, two ends thereof are respectively connected to the negative output end of the operation amplifier and the negative input end of the analog-to-digital converter;
a seventh switch, controlled by the charge sample-and-hold signal, two ends thereof are respectively connected to the positive output end of the operation amplifier and the positive input end of the analog-to-digital converter; and
an eighth switch, controlled by the discharge sample-and-hold signal, two ends thereof are respectively connected to the positive output end of the operation amplifier and the negative input end of the analog-to-digital converter.

16. The electronic apparatus according to claim 9, wherein when the capacitor is charged, the output voltage is raised to a second level from a first level, and during a period that the output voltage is raised to the second level from the first level, the chopper circuit samples and holds the output voltage; when the capacitor is discharged, the output voltage is pulled down to a fourth level from a third level, and during a period that the output voltage is pulled down to the fourth level from the third level, the chopper circuit samples, holds, and flips the output voltage, wherein the second level is larger than the first level, and the third level is larger than the fourth level.
